(19) United States
(12) Patent Application Publication
(10) Pub. No.: US 2006/0218003 A1
(43) Pub. Date: Sep. 28, 2006

(54) Automated Communication of Neighborhood Property Value Information for Real Estate Marketing

(76) Inventor: Steven L. Snyder, Sarasota, FL (US)

Correspondence Address: SMITH HOPEN, PA, 180 PINE AVENUE NORTH, OLDSMAR, FL, 34677, US

(21) Appl. No.: 11/420,353

(22) Filed: May 25, 2006

Related U.S. Application Data
(63) Continuation-in-part of application No. 09/660,118, filed on Sep. 12, 2000, now Pat. No. 7,076,448.

(51) Int. Cl. G06Q 99/00; G06F 7/00; G06F 17/00

(52) U.S. Cl. 705/1; 707/100

(57) ABSTRACT

A method for automating the periodic communication of relevant information to potential real estate customers based on recent sales transactions in predefined geographic areas. Geographic neighborhood areas are identified through a unique process that allows all elements in the program to cohesively work together. Proper identification of neighborhoods not only ensures that agents send reports to owners residing within the desired neighborhood, but it is also used as a means to ensure that the sales data used in the report to homeowners is accurate without the need for constant human intervention.

### FIELD OF INVENTION

The present invention relates generally to a method of communicating property value information, and more particularly, to a method of communicating recent property sales transactions to an owner of similar property.

### BACKGROUND OF THE INVENTION

Real estate marketing is a competitive industry. Agencies and individual sales agents go to great lengths to promote their services. It is not uncommon to see billboards, bus stops, brochures, television advertisement and the like campaigning for business. With this virtual flood of advertising, agencies are pressed to find new ways to establish relationships with new customers.

A productive, but not necessarily efficient, means of establishing customer relationships includes providing information specifically targeted at a potential customer based on the customer's personal information. For example, local sales information is typically available as a public record in the local tax collector's office. An industrious real estate agent might periodically cross-reference such records against an array of prospective customers and send them the results of the search. Providing this type of targeted information is generally well received by the prospective customer as relevant and of personal interest because for most customers, the personal dollars spent to purchase and maintain their home often represents the largest single investment in their lifetime. Even if the prospective customer is not in an immediate position for the real estate agent's services, goodwill and name recognition is achieved in the process that may be tapped at a later time. However, in order to properly research and prepare such correspondence, the real estate agent must expend considerable time and effort unrelated to showing property, closing deals and other important activities.

Because communication of recent property sales to owners in a neighborhood has traditionally represented an inefficient, but effective means of generating future leads and customer contacts, it is not an uncommon practice for this to be done by aggressive and hard-working real estate agents. However, it is also known in the industry that most real estate agents are not as aggressive in their prospecting work as they need to be to continually bring in a source of leads, and the agents that do make the time and dollar commitment to write, print, stuff, and mail periodic neighborhood property value letters do not continue after a time because they get too busy (with the leads that are generated from prior mailings) to keep it going.

What is needed is an automated method of searching, identifying and transmitting relevant property sales transactions to a prospective customer without the overhead of traditional methods. The use of computer networks, databases and document generation for the integration of such automated method is far from obvious.

Therefore, an object of this invention is to provide a method of automating the periodic communication of useful information to a potential real estate customer based on recent sales transactions.

However, in view of the prior art in at the time the present invention was made, it was not obvious to those of ordinary skill in the pertinent art how the identified needs could be fulfilled.

### SUMMARY OF THE INVENTION

The present invention solves significant problems in the art by providing a novel method of automating the periodic communication of property value information without losing the ability to customize each property owner's report through the implementation of a real estate marketing system comprising the steps of establishing geographic neighborhood values, storing at least one property owner record in a storage means, associating a sales entity with the at least one property owner record, creating a property owner profile for the at least one property owner record, establishing a connection to at least one property sales database, establishing a pre-selected search criteria based on the property owner profile, querying the least one property sales database for at least one sales transaction meeting the preselected search criteria, retrieving the at least one sales transaction returned by the query, establishing a predetermined address associated with the at least one property owner record, and reporting at least one predetermined parameter of the at least one sales transaction to the predetermined address whereby the sales entity enhances its perceived knowledge, reputation and visibility by providing relevant sales transaction information to a property owner. The at least one predetermined parameter may include, but is not limited to, the price at which the sale was made, the listing price, the date when the sales transaction occurred or the like. The at least one sales transaction may be limited to those in a predetermined geographic proximity to the predetermined address or to those of substantially similar value as an appraised value of the predetermined address.

However, if a sales entity has an office on the border between two areas (each area with their own property-listing database) the sales entity might list a single property in both property-listing databases. If this is the case, then duplicate entries may occur when both property-listing databases overlap. To resolve this problem, the present invention further comprises the steps of establishing a duplicate removal criteria, identifying at least one duplicate sales transactions retrieved from a plurality of overlapping property sales databases, and removing the at least one duplicate sales transaction. The step of establishing duplicate removal criteria may further comprise the step of matching at least one substantially similar table field value between the plurality of overlapping property sales databases. The at least one substantially similar table field value may be selected from the group consisting of listing date, contract date, sales date, listing price, sold price, subdivision, address, owner information, listing agent information, and property amenities.

A more complex issue arises when a common owner owns multiple properties. It would be inefficient to send the report of the at least one sales transactions to each property address that the common owner owns. Rather, it would be preferable that a single report go out encompassing relevant sales transactions for each individual property that the common owner owns. For example, a common owner might live in a metropolitan townhouse, but also own a beachfront cottage. That common owner might be interested in relevant sales transactions of other metropolitan townhouses similar to his or in his geographic area. In addition, the same common owner might also be interested in relevant sales transactions of other beachfront cottages.

To resolve this issue, the novel method comprises the steps of storing at least one property owner record in a storage means, creating a property owner profile for the at least one property owner record, associating a plurality of property owner records having a common owner where multiple properties owned in one neighborhood are “netted” out to enable the automated communication to focus on providing information on “different” neighborhoods where property is owned, associating a sales entity with the common owner, establishing a connection to at least one property sales database, establishing a preselected search criteria based on the property owner profile, querying the at least one property sales database for at least one sales transaction meeting the preselected search criteria, retrieving the at least one sales transaction returned by the query, grouping the at least one sales transaction according to the common owner, and reporting the at least one sales transaction across multiple properties owned in different neighborhoods to a predetermined address associated with the common owner.

The step of associating the plurality of property owner records having a common owner may further comprise the steps of establishing a substantially distinct identifier for the common owner, querying the at least one property record database for the substantially distinct identifier, retrieving the plurality of property records listed under the substantially distinct identifier, associating a single predetermined address with the common owner, and reporting the at least one sales transaction to the single predetermined address selected from the plurality of property records listed under the substantially distinct identifier. A more precise substantially distinct identifier may be obtained by the steps of accessing a tax bill mailing address, retrieving a common owner's name from the tax bill mailing address, retrieving a common owner's address from the tax bill mailing address, and forming a preselected combination of the common owner's name and the common owner's address to form the substantially distinct identifier.

The step of forming the preselected combination may further comprise parsing the tax bill mailing address for the first character of the street address, the first character of the first name, the entire last name and the first five characters of the postal code. The reason for this methodology is that human data entry can sometimes result in varying results. For example, if the mailing address is “Post Office Box 555,” a data entry operator might enter “PO Box 555,” “P.O. Box 555,” or “POB 555.” All of those entries would be correct in substance, but have different string values for the purpose of database searching. Likewise, the first name of “Donald” might also be represented as “Don” or “Donny.” However, a data entry operator will unlikely come up with variations of a last name such as “Jones” or “Smith.” Therefore, the entire last name is generally a reliable identifier. Finally, postal codes or zip codes, generally start with five digits, but may also include extra integers to more precisely define the area. However, the extra integers are often omitted and therefore are best left unread for consistency.

An alternative embodiment of the invention includes the steps of first establishing a predetermined geographic area containing prospective real estate clients. This predetermined geographic area might be a condominium, subdivision or the like. A single sales entity is assigned to the predetermined geographic area. This prevents multiple agents from overlapping their sales efforts. A list of property owners within the predetermined geographic area is assembled from public record databases, typically county tax records. In a preferred embodiment, the single sales entity reviews the list of property owners to remove an array of non-preferred clients from the list. Non-preferred client would include other, competitive real estate agents, developers and like. A property sales database is accessed which might comprise a multiple listing service or a public tax-roll database. A first array of sales records is retrieved from the database covering transactions occurred in the predetermined geographic area. This first array of sales records may include, property sales occurred in the condominium, subdivision or other geographic area designated as the predetermined geographic area. This first array is particularly relevant to the property owners with the predetermined geographic area as it provides a measure of the value of their own property. A second array of comparable sales records outside the predetermined geographic area may also be obtained. These comparable sales records are also useful to the property owners to contrast the relative value and frequency of sales in neighboring geographic areas.

At least one or more individual records from the first array of sales records may be tagged as a preferred purchase or “best buy.” A string field description is entered providing a basis for selecting the preferred purchased. Examples of preferred purchase strings may include, “open floor plan and very spacious,” “lake & golf course view,” “close to the beach,” or “great price for Bonita Bay.” The individual document template is then populated with the string field description.

An additional step of the invention also includes establishing a selectable column field for the report. For example, in a certain area, boating canals may run through many neighborhoods, but on an every other street basis. Homes backing up to a canal with boat dock access typically sell for substantially more than homes across the street from them that are landlocked. Therefore, it would be desirous for a sales entity to designate “waterfront” or “water access” for the special column so that recipients of the report can understand why some homes sell for more than other comparable homes in the same neighborhood.

In an alternative embodiment of the invention, an additional step may include a Boolean operator determinative of whether vacant lot information is excluded or included in the report.

The method may also integrate with a docketing or contact management system wherein the individual property owner receiving a report is marked for a follow up telephone call after a predetermined time period subsequent to the transmission of the report. And if the assigned agent does not have the time to make a follow-up phone call, the call may be made by a telemarketing center of licensed real estate agents working for the company providing the automated property value communication. Any leads generated from these calls can also be recorded in the contact management system for later review and follow-up.

Accordingly, it is an object of this invention to provide a method of consistently and efficiently communicating unduplicated property value information relating to recent or pending sales transactions to property owners identified as prospective customers by a sales agent using a customizable report format.

Another object of this invention is to provide a method of identifying multiple properties owned by an individual property owner and communicating a single report encompassing the different multiple properties owned by the individual owner.

Another object of this invention is to provide a method of assigning target neighborhoods to sales agents to prevent an overlap of communication and to give agents a reason to spend their time and resources to consistently communicate property value information to property owners over a long and extended timeframe.

An advantage of the invention is that property owners receive consistent valuable customized information illustrating the relative value of their own property based on recent and pending sales transactions occurring in their neighborhood as well as other similar neighborhoods in the surrounding area. Research done among owners receiving the communications to-date has shown that 9 out of 10 want to continue receiving the communication.

Another advantage of the invention is that real estate agents and agencies utilize less time organizing property transaction data to create reports, and therefore may spend their time on more profitable tasks.

Another advantage of the invention is that it gives many agents the ability to send out a valuable, customized property report on a consistent basis who otherwise would not have “gone to the trouble” of periodically gathering the information, writing the document, and disseminating the communication on their own.

Another advantage of the invention is that it gives back control over the prospecting of customers to real estate agency owners. Many agents would not take the initiative on their own to consistently prospect themselves to a large base of potential customers (not surprisingly, most agents are not “go-getters” —in the real estate industry it is commonly known that 80% of the business is done by 20% of the sales force). However, with this invention, agency business owners now have a valuable prospecting and marketing tool that they can offer agents (or require them to use) that takes little effort on the agent's part to implement, but has a proven track record to produce leads because it offers prospective customers a consistently delivered free customized report showing changes in property values in their neighborhood as well as similar surrounding neighborhoods.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a functional block diagram of the method of communicating property value information according to the invention.

FIG. 2 is a functional block diagram of multiple property databases forming the property sales record database described in the invention.

FIG. 3 is a functional block diagram of an illustrative array of search criteria elements that may be combined to establish a search criteria for the property owner.

FIG. 4 is a functional block diagram showing an illustrative example of SQL syntax to execute the search query.

FIG. 5 is a functional block diagram including the step of removing duplicate sales transactions from the sales transaction retrieved from the database query.

FIG. 6 is a detailed function block diagram of a preferred method of removing duplicate sales transactions.

FIG. 7 shows an array of database field results to include in a report to the property owner.

FIG. 8 is a functional block diagram of a property owner with title to multiple properties in two different regions resulting in three reports being generated for the individual property owner.

FIG. 9 is a functional block diagram showing the additional step of associating a property owner profile with commonly owned properties by that owner.

FIG. 10 is a functional block diagram of the method of identifying a common property owner for multiple properties based on tax roll data, even if the data is entered inconsistently.

FIG. 11 is a functional block diagram of the method of generating report documents to property owners based on populating previously created templates and populating them with property sales data.

FIG. 12 is a functional block diagram of the invention further showing the step of removing non-preferred property owners.

FIG. 13 is a functional block diagram of the invention further showing the step of retrieving comparable sales records outside a predetermined geographic area.

FIG. 14 is a functional block diagram of the invention further showing the steps of tagging certain properties as preferred purchases and marking records for follow up telephone calls.

FIG. 15 is a functional block diagram of the invention further showing the steps of establishing a selectable column field for reporting.

FIG. 16 is a functional block diagram of the invention further showing the steps of establishing a neighborhood ID.

### DETAILED DESCRIPTION OF THE PREFERRED EMBODIMENT

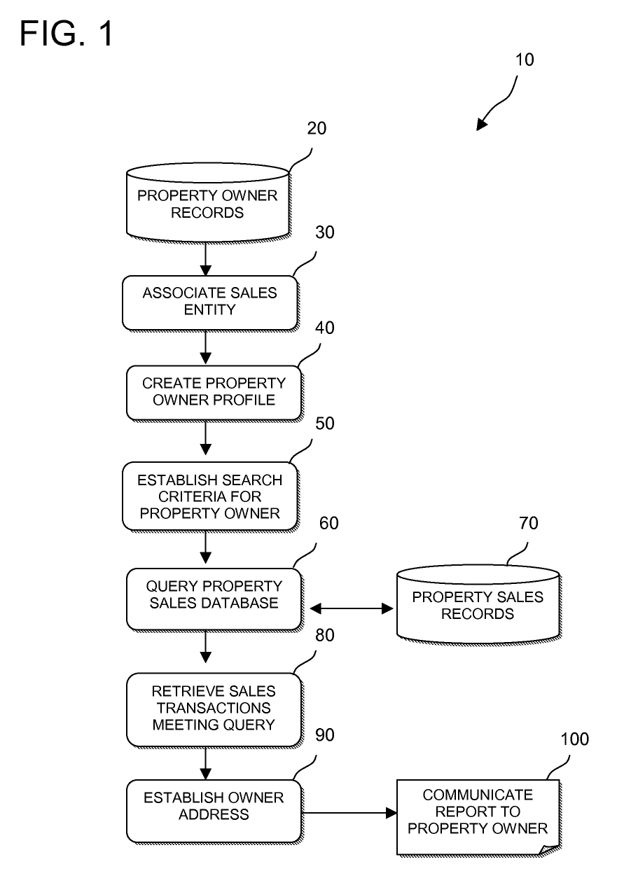

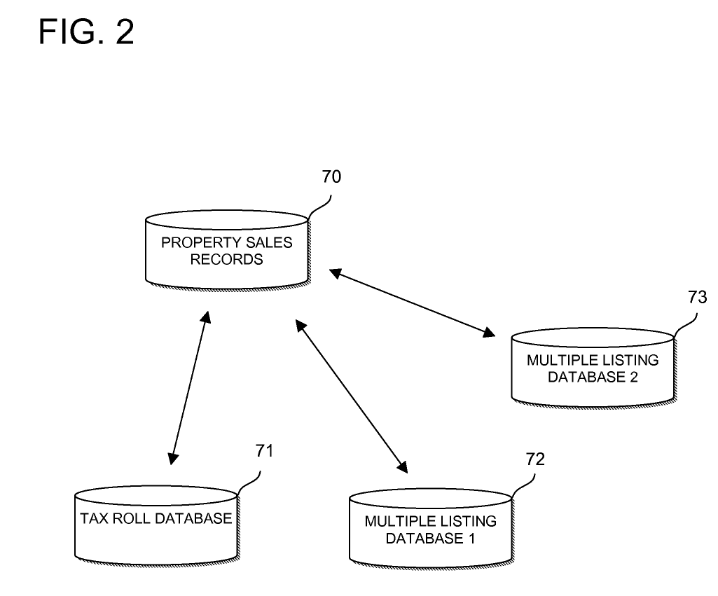

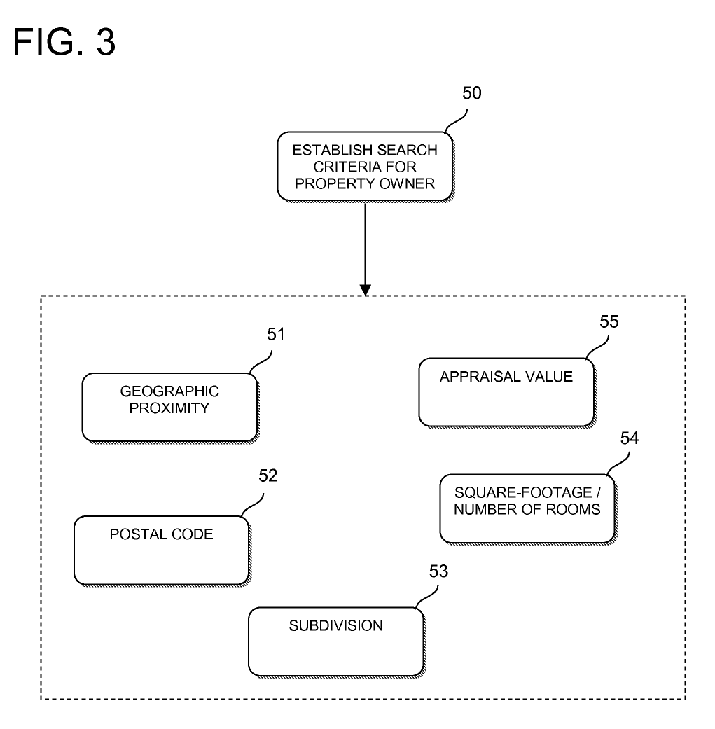

Referring initially to FIG. 1, it will there be seen that a first embodiment of the present invention is denoted as a whole by the reference number 10. The invention comprises the steps of storing at least one property owner record in a storage means 20, associating a sales entity with the at least one property owner record 30, creating a property owner profile for the at least one property owner record 40, establishing a connection to at least one property sales database 70, establishing a preselected search criteria based on the property owner profile 50, querying the at least one property sales database 60 for at least one sales transaction meeting the preselected search criteria, retrieving the at least one sales transaction returned by the query 80, establishing a predetermined address 90 associated with the at least one property owner record, and reporting at least one predetermined parameter of the at least one sales transaction to the predetermined address 100 whereby the sales entity enhances its perceived knowledge, reputation and visibility by providing relevant sales transaction information to a property owner. In FIG. 2, the property sales database 70 may actually comprise a plurality of databases such as a tax roll database 71, and multiple listing databases 72 and 73 which may overlap in territory. In FIG. 3, the preselected search criteria based on the property owner profile 50 may be generated of any combination of factors such as geographic proximity 51, postal code 52, subdivision identity 53, the dimensions and number of rooms of the houses 54, and the appraisal value 55 of the houses. When establishing the search criteria 50, it is important to anticipate the type of information most desired by the prospective real estate customer.

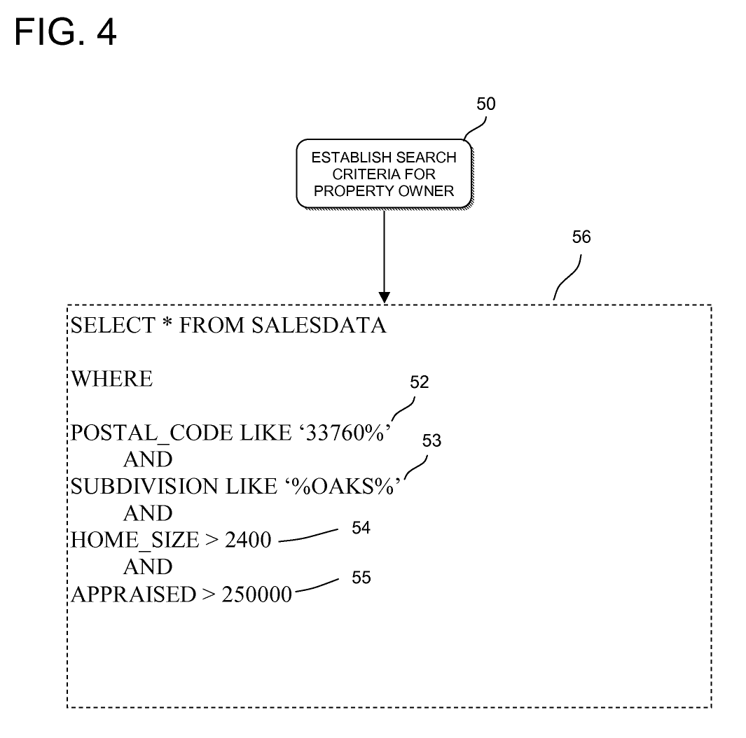

FIG. 4 illustrates an example of the search criteria 50 based on standardized Search Query Language (SQL) syntax 56. The initial statement SELECTS all the records from a database named SALESDATA with a number of conditions. The first condition 52 requires that any property included in the search have a postal code with the first five integers of “33760.” By including the “%” sign after the first five integers, properties that further specify an additional four-digit postal code suffix will also be selected. The second condition 53 requires that any property be located in a subdivision that contains the word “OAKS” anywhere in the database field. By including the “%” sign before and after “OAKS,” variances in the database field for the subdivision name do not negatively affect the search results. For example, the second condition 53 would return properties listed in “THE OAKS,” “OAKS,THE,” and simply “OAKS.” The third condition 54 requires that any property returned in the search be greater than 2,400 square feet in area and the fourth condition 55 requires that the appraised value of any property returned in the search be greater than $250,000. Of course, SQL syntax is well known in the art and a large number of permutations are available for specifying the types of properties to be returned in the search.

Geographic neighborhood areas are identified through a unique process that allows all elements in the program to cohesively work together. Proper identification of neighborhoods not only ensures that agents send reports to owners residing within the desired neighborhood, but it is also used as a means to ensure that the sales data used in the report to homeowners is accurate without the need for constant human intervention.

The present invention provides a method for automating the periodic communication of useful information to a potential real estate customer based on recent sales transactions enabling the agent to more effectively use their time to work directly with homeowners.“The inventive method allows reports to be prepared for less money than it would cost the agent to do it themselves without loss of accuracy which is critical to establishing a professional credible image for the mailing agent as the local neighborhood expert.

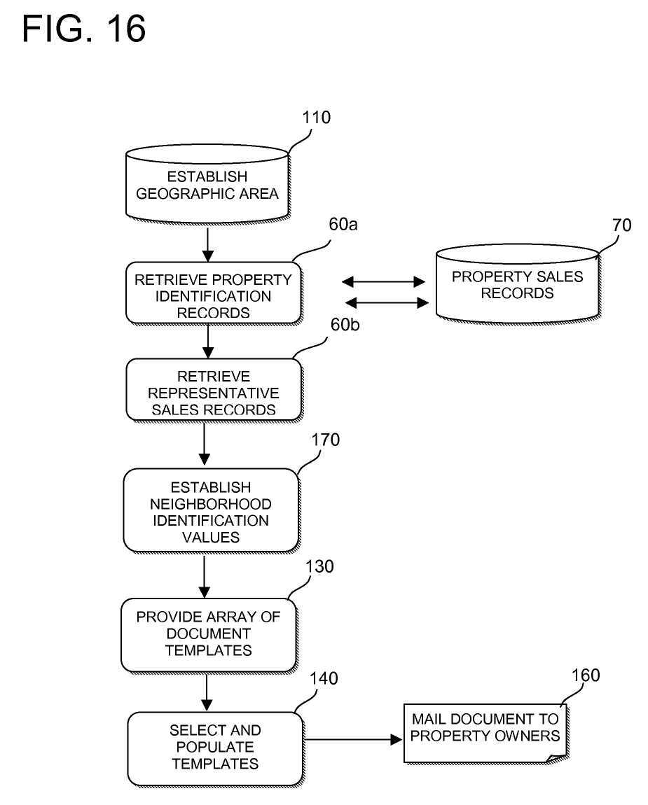

The steps employed to identify neighborhoods, shown in FIG. 16 are to download both the public records 60a (such as a county's tax roll) as well as sales data databases 70 (such as the Multiple Listing Service, a.k.a., MLS) for a particular geographic area 110, i.e. county. The legal descriptions of individual properties contained in public records are compared to the description used by real estate agents selling similar properties as detailed within their local sales data 60a.

For example, if the description used by the agent is the same as public records (i.e., they both say a particular property resides within a neighborhood named “Forest Lakes”), then the commonly used neighborhood name is used. However, if the agent says the property they listed belongs in a neighborhood named “Country Estates” while the property records has a description of “Forest Lakes”, the agent is assumed to be the local expert and the property is recorded in the method's database as “Country Estates.” If only one source gives the property a description name, that name is used. If neither source provides a description of the property, then the name of the street (with associated five-digit zip code) is used as the neighborhood name (such as properties belonging to the neighborhood of “Riverside Drive” in zip code 34243). In each case, a neighborhood “Subdivision ID” is assigned to the property that consists of the first two letters of the county name followed by the local five-digit zip code and then the name description given to the property's neighborhood. In the preceding examples, Forest Lake in zip code 34243 within Escambia County would have a Subdivision ID of “ES_{—}34243_Forest Lakes” while Riverside Drive would be “ES_{—}34243_Riverside Drive”.

Continuing now with FIG. 16, once all properties in public records are categorized into unique geographic neighborhood definitions 175, these records become the FOUNDATION for all databases used in preparation of property reports 140 sent to homeowners 160. Specifically, the public records are used to form mailing lists for each neighborhood.

The neighborhood identification values are also used to ensure that each property brought into the sales database on a daily basis is associated with the correct neighborhood. To do this, a “matching” process is executed between the sales database and public records every time sales data is brought into the method's database in the following order of matching priority: (1) Property Parcel ID#; (2) Full Address; (3) Partial Address; and (4) Neighborhood Name by Street Name and Zip Code. For address matching to occur between public records and the sales database, all items used in the matching process are “normalized” in advance. For example, street “types” such as “drive” and “road” are updated in both databases to use the same abbreviations of “Dr” and “Rd” to ensure proper and effective matching. Similarly, street directions are normalized such as “East” is always “E” and “North-West” is always “NW”. Zip codes are always reduced to a five-digit character between both the public records and sales database and county names are checked to ensure they are spelled the same with no differences in abbreviations or other criteria.

To illustrate, as data is downloaded daily from the local MLS into the method's sales database, each listing is compared to the method's public records database to see if there is a match between what the listing agent entered as the Property Parcel ID# and the ID# that exists in the public records. If the match exists, then the neighborhood Subdivision ID associated with that Property Parcel ID# in the public records is given to the listing brought in from the MLS. If a match is not made, then it goes to the next priority level which is to match on Full Address where the following must be the same between both the public records and the sales listing—they both must match on street name, street number, street direction, zip code and county name. If this match is made, the Subdivision ID associated with the neighborhood in the public records is given to the listing in the MLS. If a match is not made, it goes to the next priority level to match on a partial address. However, for a match to be considered using a “partial address”, the combination of elements in the address MUST BE UNIQUE within the county. For example, if the partial address for a listing using street number, street name and county name is not unique (because two occurrences exist of 1234 Main Street in Escambia county), then this partial address can't be used for matching purposes. On the other hand, if 1234 Main Street in zip code 34232 is unique, then it can be used to match public records with the sales database to properly identify the neighborhood the listing belongs to. Lastly, if neither a Parcel ID# or Full/Partial Address works to yield a match between public records and the sales database, then a combination of the neighborhood name given by the real estate agent with the street name and zip code is used to see if it matches against the public records to identify the appropriate Subdivision ID.

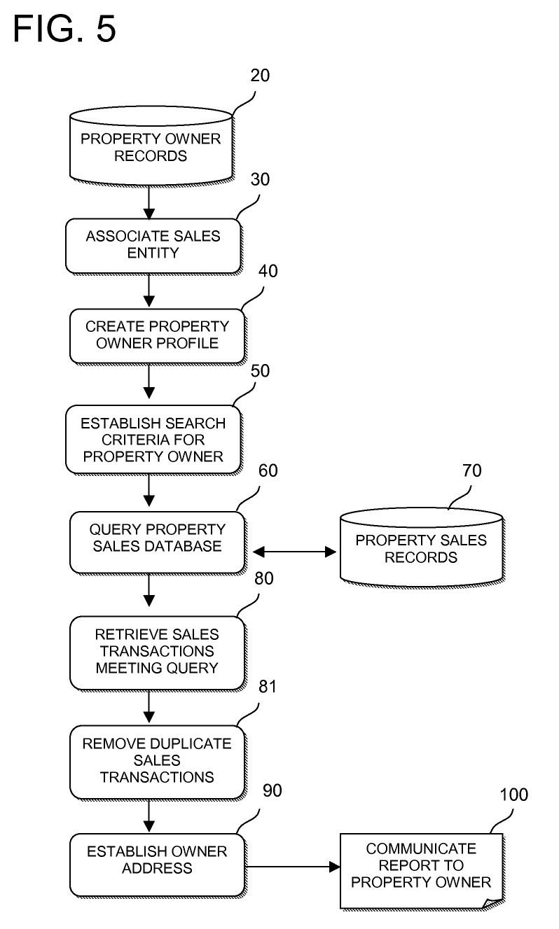

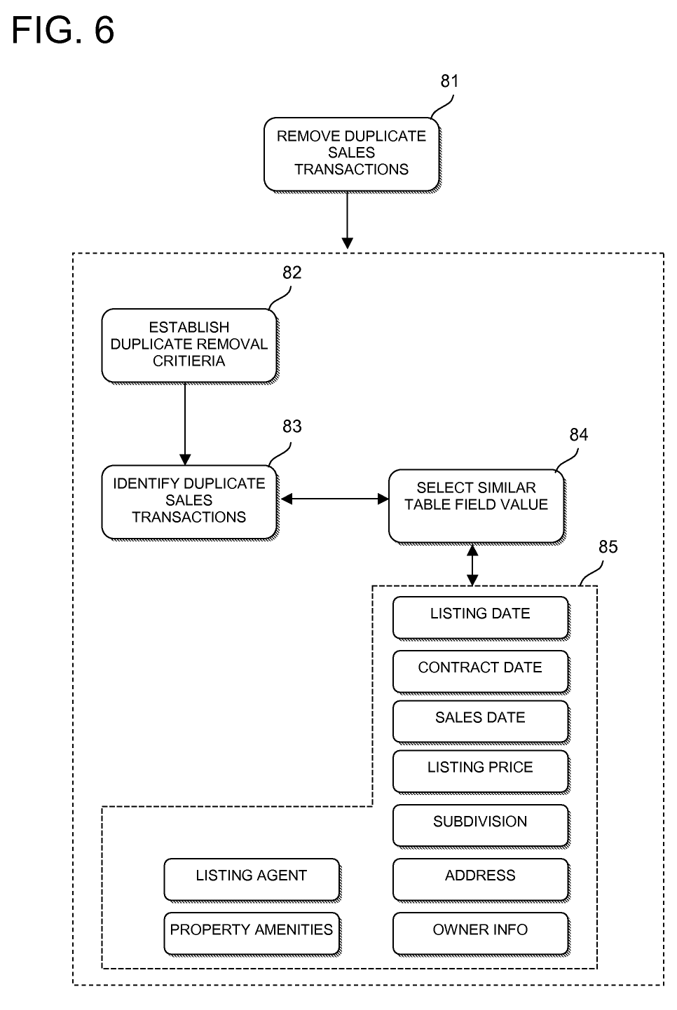

If a sales entity has an office on the border between two areas (each area with their own property-listing database) the sales entity might list a single property in both property-listing databases. If this is the case, then duplicate entries may occur when both property-listing databases overlap. To resolve this problem, the present invention further comprises the steps of establishing a duplicate removal criteria 82, identifying at least one duplicate sales transactions retrieved from a plurality of overlapping property sales databases 83, and removing the at least one duplicate sales transaction 81 (FIGS. 5-6). As shown in FIG. 6, the step of establishing duplicate removal criteria 82 may further comprise the step of matching at least one substantially similar table field value 84 between the plurality of overlapping property sales databases. The at least one substantially similar table field value may be selected from the group 85 consisting of listing date, contract date, sales date, listing price, sold price, subdivision, address, owner information, listing agent information, and property amenities.

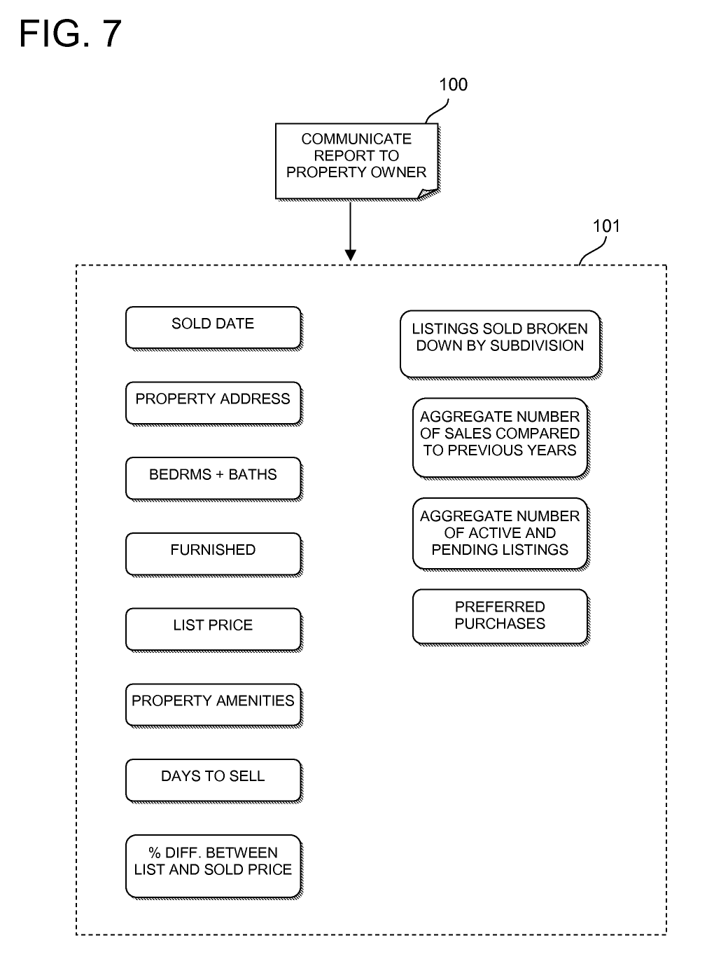

FIG. 7 illustrates an array of exemplary information 101 which may be included in the step of reporting at least one predetermined parameter of the sales transactions to the predetermined address 100. Such information may include sold date, property address, number of rooms, whether the property is furnished, list price, property amenities, days the property took to sell, the percentage difference between the list price and the sold price, the listing sold grouped by subdivision, the aggregate number of sales compared to previous years, the aggregate number of active and pending listing and preferred purchases determined by the sales entity.

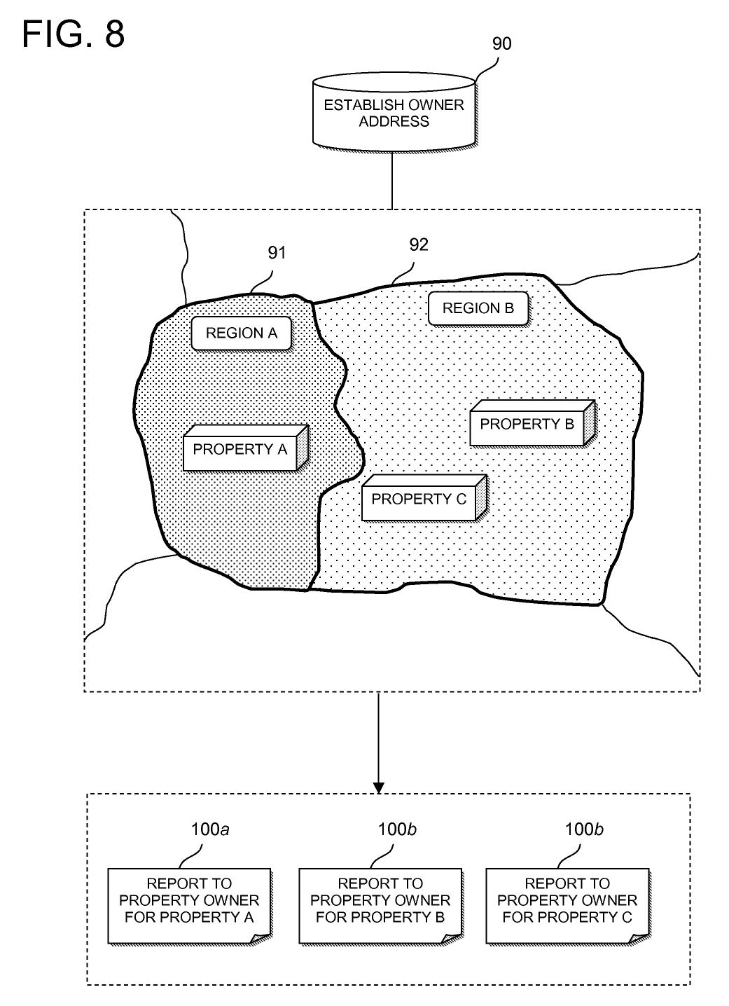

A more complex issue arises when a common owner owns multiple properties. As shown in FIG. 8, a common owner 90 owns Property A in Region A 91 and also owns Properties B and C in Region 92. Without recognizing that a common owner exists for Properties A-C, three separate reports 100a-c will be mailed to the same property owner. It would be inefficient to send the report of the at least one sales transactions to each property address that the common owner owns. Rather, it would be preferable that a single report go out encompassing relevant sales transactions for each individual property that the common owner owns. Furthermore, a first sales entity might represent the properties in Region A while a second sales entity might represent the properties in Region B. It is undesirable for the first and second sales agents to compete for the same property owner's real estate business.

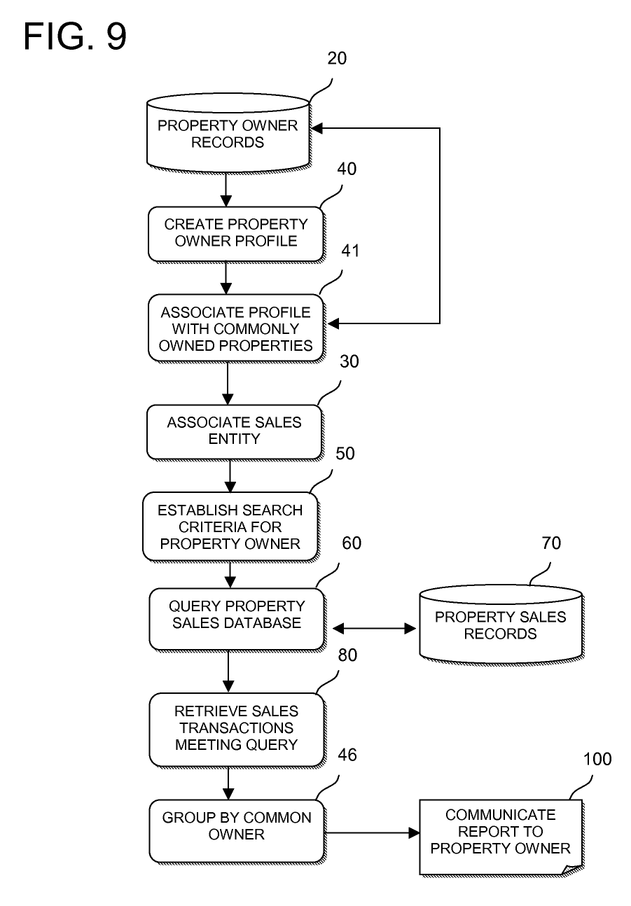

To resolve this issue, the novel method as shown in FIG. 9 comprises the steps of storing at least one property owner record in a storage means 20, creating a property owner profile for the at least one property owner record 40, associating a plurality of property owner records having a common owner 41, associating a sales entity with the common owner 30, establishing a connection to at least one property sales database 70, establishing a preselected search criteria based on the property owner profile 50, querying 60 the at least one property sales database 70 for at least one sales transaction meeting the preselected search criteria 50, retrieving the at least one sales transaction returned by the query 80, grouping the at least one sales transaction according to the common owner 46, and reporting the at least one sales transaction to a predetermined address associated with the common owner 100.

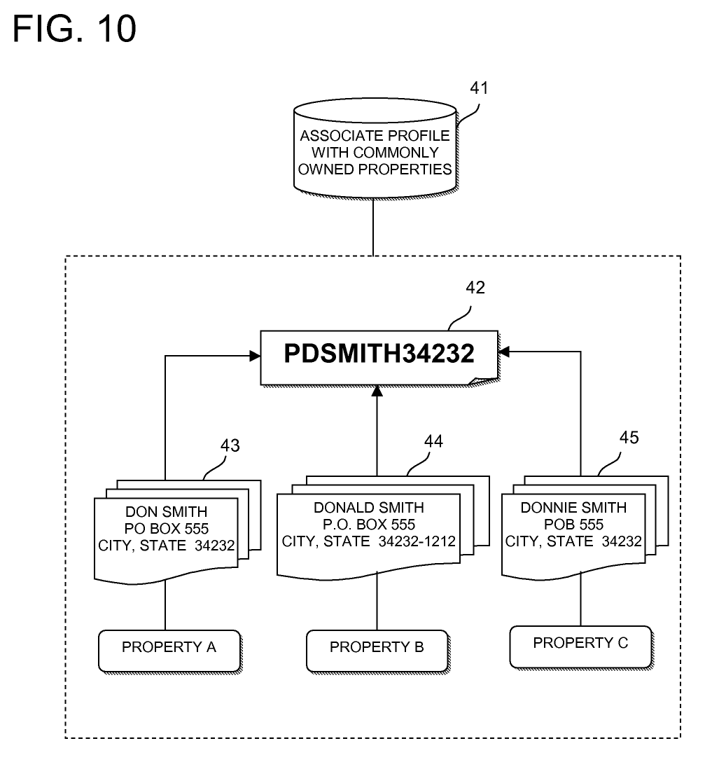

As shown in FIGS. 9-10, the step of associating the plurality of property owner records having a common owner may further comprise the steps of establishing a substantially distinct identifier 93 for the common owner, querying the at least one property record database 70 for the substantially distinct identifier 93, retrieving the plurality of property records listed under the substantially distinct identifier 80, associating a single predetermined address with the common owner 46, and reporting the at least one sales transaction to the single predetermined address selected from the plurality of property records listed 100 under the substantially distinct identifier 93. A more precise substantially distinct identifier 93 may be obtained by the steps of accessing a tax bill mailing address, retrieving a common owner's name from the tax bill mailing address, retrieving a common owner's address from the tax bill mailing address, and forming a preselected combination of the common owner's name and the common owner's address to form the substantially distinct identifier 93.

FIG. 10 shows the step of forming the preselected combination by parsing the tax bill mailing address for the first character of the street address, the first character of the first name, the entire last name and the first five characters of the postal code. The reason for this methodology is that human data entry can sometimes result in varying results. For example, if the mailing address is “Post Office Box 555,” a data entry operator might enter “PO Box 555,” “P.O. Box 555,” or “POB 555.” All of those entries would be correct in substance, but have different string values for the purpose of database searching. Likewise, the first name of “Donald” might also be represented as “Don” or “Donnie.” However, a data entry operator will unlikely come up with variations of a last name such as “Jones” or “Smith.” Therefore, the entire last name is generally a reliable identifier. Finally, postal codes or zip codes, generally start with five digits, but may also include extra integers to more precisely define the area. However, the extra integers are often omitted and therefore are best left unread for consistency.

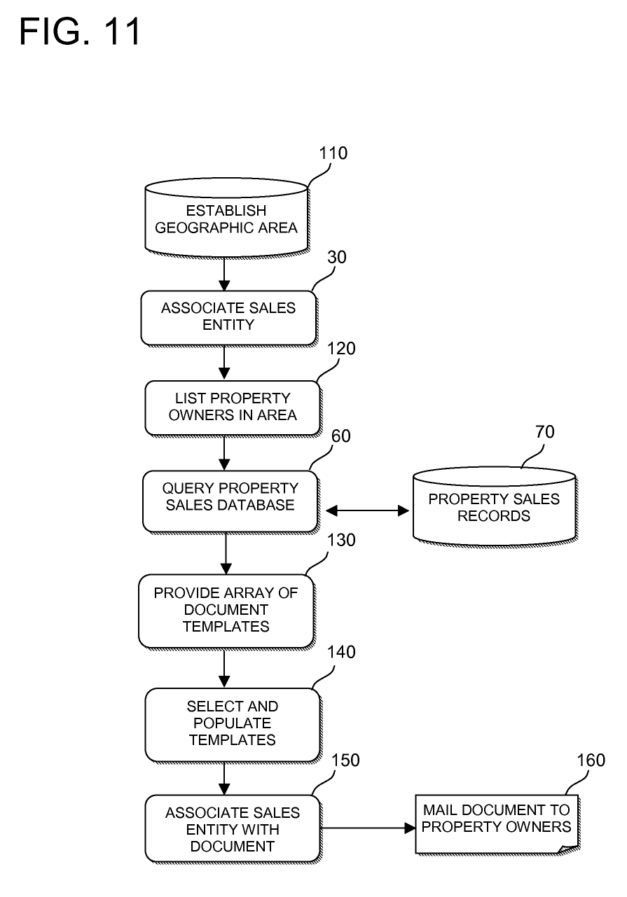

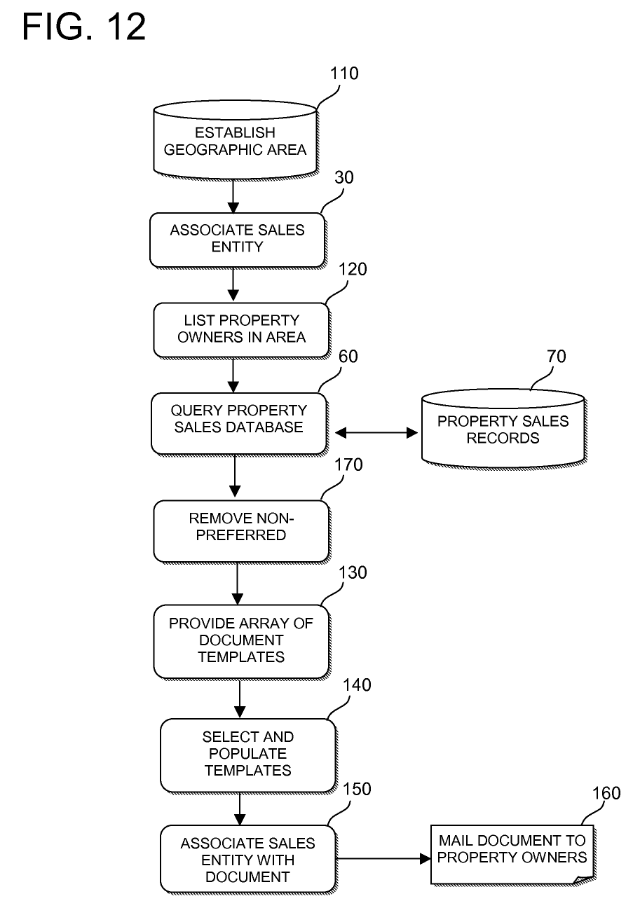

FIGS. 11 and 12 show an alternative embodiment of the invention including the steps of first establishing a predetermined geographic area 110 containing prospective real estate clients. This predetermined geographic area might be a condominium, subdivision or the like. A single sales entity is assigned to the predetermined geographic area 30. This prevents multiple agents from overlapping their sales efforts. A list of property owners within the predetermined geographic area is assembled 120 from public record databases, typically county tax records. In a preferred embodiment, the single sales entity reviews the list of property owners to remove an array of non-preferred clients from the list 170. Non-preferred client would include other, competitive real estate agents, developers and like.

An array of document templates 130 is provided to the sales entity. While the sales entity may type own their own letter, choosing from the array of document templates 130 saves time and effort.

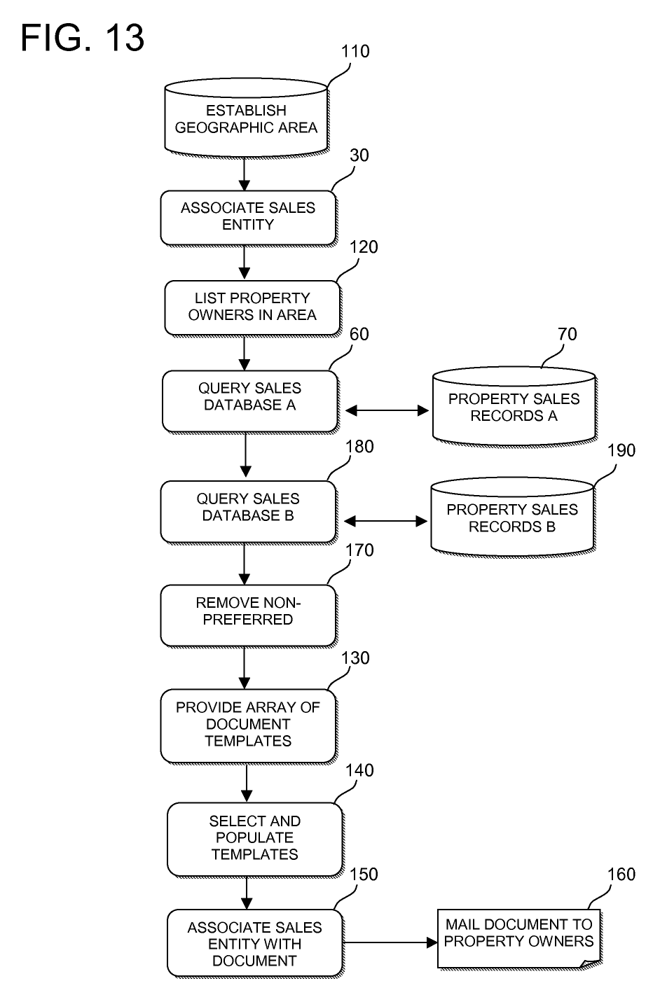

A property sales database 70 is accessed which might comprise a multiple listing service or a public tax-roll database. In an alternative embodiment illustrated in FIG. 13, a first array of sales records is retrieved from the database covering transactions occurred in the predetermined geographic area 60. This first array of sales records may include, property sales occurred in the condominium, subdivision or other geographic area designated as the predetermined geographic area. This first array is particularly relevant to the property owners with the predetermined geographic area as it provides a measure of the value of their own property. A second array of comparable sales records outside the predetermined geographic area 180 may also be obtained. These comparable sales records are also useful to the property owners to contrast the relative value and frequency of sales in neighboring geographic areas.

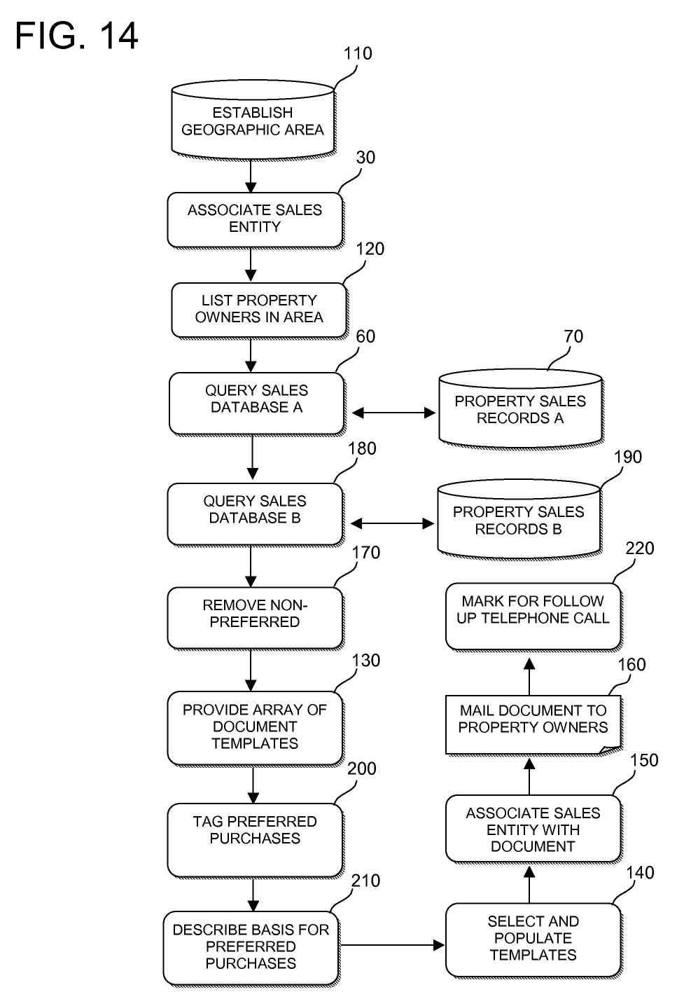

In FIG. 14 at least one or more individual records from the first array of sales records may be tagged as a preferred purchase 200 or “best buy.” A string field description is entered 210 providing a basis for selecting the preferred purchased. Examples of preferred purchase strings may include, “open floor plan and very spacious,” “lake & golf course view,” “close to the beach,” or “great price for Bonita Bay.” The individual document template is then populated with the string field description 140.

The method may also integrate with a docketing or contact management system wherein the individual property owner receiving a report is marked for a follow up telephone call 220 after a predetermined time period subsequent to the transmission of the report. It is also preferred that the property owner telephone number be cross-referenced against a list of no-call numbers for regulatory compliance.

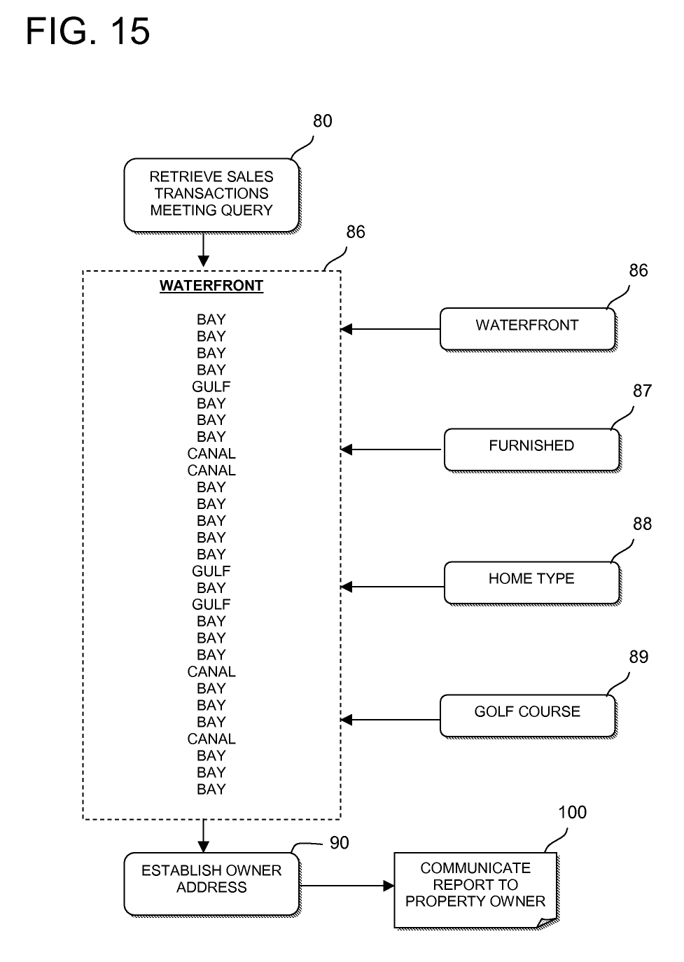

In FIG. 15, a selectable column field 86 is provided to help compare otherwise similar properties. Because there is a limited amount of space on any screen display or piece of paper, the sales entity will appreciate the freedom to include particularly relevant information when comparing properties. For many properties, waterfront access is highly determinative of the value of the property. Accordingly, the sales entity might include waterfront data 86 in the report. For other types of property, furnishings 87, home type 88, or a golf course view 89 might be more relevant to prospective customer.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A method of communicating property value information comprising the steps of: creating a predetermined geographic area that contains potential real estate clients; accessing a property sales database;
retrieving a first array of sales records from the database in the predetermined area;
associating at least one neighborhood identification value to the first array of sales records; and
transmitting a report comprising at least a portion of said first array of sales records associated with at least one neighborhood identification value for said predetermined geographic area to said potential real estate clients.

2. The method of claim 1 further comprising the step of establishing a property identification database comprising neighborhood identification values for said predetermined geographic area.

3. The method of claim 1 wherein the neighborhood identification value is associated with the first array of sales records responsive to a correlation of a location parameter in the property sales database and the property identification database.

4. The method of claim 3, wherein the neighborhood identification value is selected from the group consisting of neighborhood name, subdivision name, street name, zip code, and a combination thereof.

5. The method of claim 3, wherein the location parameter is selected from the group consisting of the property parcel identification number, neighborhood name, subdivision name, street name, zip code and a combination thereof.

6. The method of claim 3, further comprising the step of normalizing location parameters.

7. The method of claim 1 further comprising the step of associating a secondary identification value to the first array of sales record.

8. The method of claim 5 wherein the secondary identification value comprises at least a portion of the county name of the sales record and the five digit zip code.

9. The method of claim 2 wherein the property identification database is established by:
retrieving at least one representative sales record having predetermined criteria in a predetermined geographic area from a property sales database;
retrieving a property identification record in a predetermined geographic area from a property identification database;
comparing the representative sales record to the identification record to determine a correlation in identifying information contained therein;
assigning a neighborhood identification value for the identification record responsive to the correlation of identifying information; and
storing said identification value.

10. The method of claim 9 wherein the predetermined criteria used to identify the representative sales record are selected from the group consisting of year built, square footage, geographic proximity to the property of the sales record and price.

11. The method of claim 9 wherein the neighborhood identification value comprises the identifying information associated with the sales record, responsive to the presence of identifying information common to the sales record and identification record.

12. The method of claim 9 wherein the neighborhood identification value comprises the identifying information associated with the sales record, responsive to the lack of identifying information common to the sales record and identification record.

13. The method of claim 9 wherein the neighborhood identification value comprises the identifying information associated with the identification record, responsive to the lack of identifying information associated with the sales record.

14. The method of claim 9 wherein the neighborhood identification value comprises at least a portion of the property address, responsive to the lack of identifying information associated with the sales record and the lack of identifying information associated with the identification record.

15. The method of claim 1, further comprising the step of assigning a single sales entity to said predetermined geographic area.

16. The method of claim 15, further comprising the step of formatting said report to show said single sale entity as an author.

17. The method of claim 1 further comprising the step of removing from said potential client list an array of non-preferred property owners.

18. The method of claim 1 further comprising the steps of retrieving a secondary sales record from said property sales database outside of said predetermined geographic area and including said secondary sales record in said report, said secondary sales record having pre-selected criteria comparable to said sales record.

19. The method of claim 1 further comprising the step of marking said property owner for a follow up telephone call.

20. The method of claim 1 wherein creating the report further comprises the steps of:
providing an array of report templates;
selecting an individual report template from said array of report templates;
populating said individual report template with at least a portion of said sales record; and
addressing said individual report template an individual property owner from said list of property owners; and
mailing said report template to said property owners in said list of property owners.

21. The method of claim 20 wherein the pre-selected criteria are selected from the group consisting of year built, square footage, geographic proximity to the property of the sales record and price.

22. The method of claim 20, further comprising the steps of:
identifying the sales record as a preferred purchase;
entering a string field description providing a basis for selecting said preferred purchase; and
populating said individual report template with said string field description.
